(19) United States
(12) Patent Application Publication
(10) Pub. No.: US 2007/0244649 A1
(43) Pub. Date: Oct. 18, 2007

(54) Automated update of microarray data processing inputs

(76) Inventors: Scott Lee Medberry, San Carlos, CA (US); Xiangyang Zhou, Mountain View, CA (US); Amitabh Shukla, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/406,441

(22) Filed: Apr. 18, 2006

(51) Int. Cl. G06F 19/00

(52) U.S. Cl. 702/19

(57) ABSTRACT

A method and device for supplying array data processing inputs, such as design files and protocols, for analyzing a microarray are disclosed herein. The user is able to access from a client computer, without the user specifying the network location, a storage unit at a predetermined network location, and receive into the computer from the storage unit through the network connection the array data processing inputs.

### BACKGROUND

Microarrays find a wide range of applications in molecular genetic research and in disease detection. A “microarray” or “DNA microarray” is a high-throughput hybridization technology that allows biologists to probe the activities of thousands of genes under diverse experimental conditions. Microarrays function by selective binding (hybridization) of probe DNA sequences on a microarray chip to fluorescently-tagged DNA or RNA fragments from a biological sample. The amount of fluorescence detected at a probe position can be an indicator of the relative expression of the gene bound by that probe or relative amount of DNA present. Any given microarray may employ a single channel or single color platform on which only a single experiment is run, or a multi channel or multi color platform on which multiple experiments are run. A common multi channel example is a two channel platform where one experiment is color-coded with a first color (e.g., color-coded green) and the other channel is color-coded with a second color (e.g., color-coded red). Such an arrangement may be used to simultaneously run a reference sample (experiment) and a test sample (experiment) and differential expression values may be calculated from a comparison of the results.

To analyze the typically vast amounts of data typically to be derived from each microarray, computers are used for data processing. In addition to the experimental data read from a microarray, microarray data processing programs typically need to utilize data processing inputs such as array annotations, array design parameters and analysis protocol. Microarrays contain a grid or array of features, with each feature containing DNA molecules of only one specific sequence and where most features typically contain DNA of a different sequence. Array annotations provide information about each of the features on the array such as sequence information, names for this sequence, and biological information linked to that sequence. Design parameters specify the parameters of the grid or array of features, including the general layout, and direct or indirect reference to indicate where each feature is positioned on the solid substrate of the microarray. Analysis protocols describe the steps, parameters, algorithms and methods that an analysis software should use to correctly process the microarray data, including fluorescent images of the microarray.

Data processing inputs have traditionally been supplied to the uses through a variety of channels. For example, CD-ROMs containing such information are often shipped with blank microarrays. Data analysis software is often preloaded with such information. Data processing inputs often can also be downloaded from network locations. Various data processing inputs may be revised from time to time. With the traditional distribution systems for data processing inputs, it is often cumbersome or difficult for the end user to track which version of the information is the most up-to-date. It is also often difficult to efficiently distribute data processing inputs and the updates on a user-specific basis with the conventional distribution systems.

### SUMMARY

In general, this patent relates to providing automated microarray data processing inputs. More specifically, this application relates to automated retrieval, or automated initiation of retrieval, of data processing inputs from a first location to a second location, e.g., from a remote a network location to a local processing location.

In one aspect, a method of supplying array data processing inputs for analyzing a microarray includes accessing, from a computer, a storage unit via a predetermined network connection without a user of the computer specifying the network location; and receiving into the computer from the storage unit through the network connection the array data processing inputs.

In another aspect, a method for supplying an array data processing input for analyzing a microarray includes storing the array data processing data input at network location accessible by a computer connected to the network location via a network connection; requiring an access credential to be supplied from the computer; and determining whether to transmit the array data processing input to the computer based on the access credential.

In another aspect, a device for analyzing a microarray comprises a computer having a network interface adapted to enable the computer to access a storage unit via a network connection; and a computer-readable medium in data communication with the computer, the medium having stored thereon codes that, when executed by the computer, causes the computer to retrieve to the computer, through the network connection, the array data processing inputs from the network location without a user of the computer specifying the network location.

### BRIEF DESCRIPTION OF THE DRAWINGS

FIG. 1 shows a computer connected to a server via a network connection in one embodiment;

FIG. 2 outlines a method for supplying an array data processing input in another possible embodiment;

FIG. 3 outlines a method for supplying an array data processing input in another possible embodiment; and

FIG. 4 shows a computer screenshot in a process of supplying an array data processing input in another possible embodiment.

### DETAILED DESCRIPTION

Definitions:

A “microarray” or “DNA microarray” is a high-throughput hybridization technology that allows biologists to probe the activities of thousands of genes under diverse experimental conditions. Microarrays function by selective binding (hybridization) of probe DNA sequences on a microarray chip to fluorescently-tagged nucleic acid fragments from a biological sample. The amount of fluorescence detected at a probe position can be an indicator of the relative expression of the gene bound by that probe or amount of DNA present in a sample. Any given microarray may employ a single channel or single color platform on which only a single experiment is run, or a multi channel or multi color platform on which multiple experiments are run. A common multi channel example is a two channel platform where one experiment is color-coded with a first color (e.g., color-coded green) and the other channel is color-coded with a second color (e.g., color-coded red). Such an arrangement may be used to simultaneously run a reference sample (experiment) and a test sample (experiment) and differential expression values may be calculated from a comparison of the results.

An “array,” or “chemical array' used interchangeably includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), polypeptides (e.g., proteins), carbohydrates, lipids, etc.) associated with that region. As such, an addressable array includes any one or two or even three-dimensional arrangement of discrete regions (or “features”) bearing particular biopolymer moieties (for example, different polynucleotide sequences) associated with that region and positioned at particular predetermined locations on the substrate (each such location being an “address”). These regions may or may not be separated by intervening spaces. In the broadest sense, the arrays of many embodiments are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3¢ or 5¢ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm2 or even less than 10 cm2. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations.

Each array may cover an area of less than 100 cm2, or even less than 50 cm2, 10 cm2 or 1 cm2. In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays may be fabricated using drop deposition from pulse jets of either precursor units (such as nucleotide or amino acid monomers) in the case of in situ fabrication, or the previously obtained biomolecule, e.g., polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein.

In those embodiments where an array includes two more features immobilized on the same surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., polynucleotides, to be evaluated by binding with the other).

“Chromosome” refers to a continuous, piece of DNA, which may contain many genes, regulatory elements, and other intervening nucleotide sequences.

“Protein expression” refers to the level, amount and time-course of one or more proteins in a particular cell, tissue or organism.

“Protein expression analysis” refers to methods for isolating, identifying, and/or quantifying proteins to determine their function and role in various physiological processes. Examples of protein expression analysis are described in Published U.S. Patent Application Nos. 20050233337 and 20040115722, which is hereby incorporated by reference.

“Location analysis” refers to analysis methods used to determine the locus (i.e. a fixed position in a genome) corresponding to a biological phenomenon of interest. An example of location analysis is described in U.S. Pat. No. 6,410,243, which is incorporated by reference herein.

### Embodiments

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Additionally, the embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented operations running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

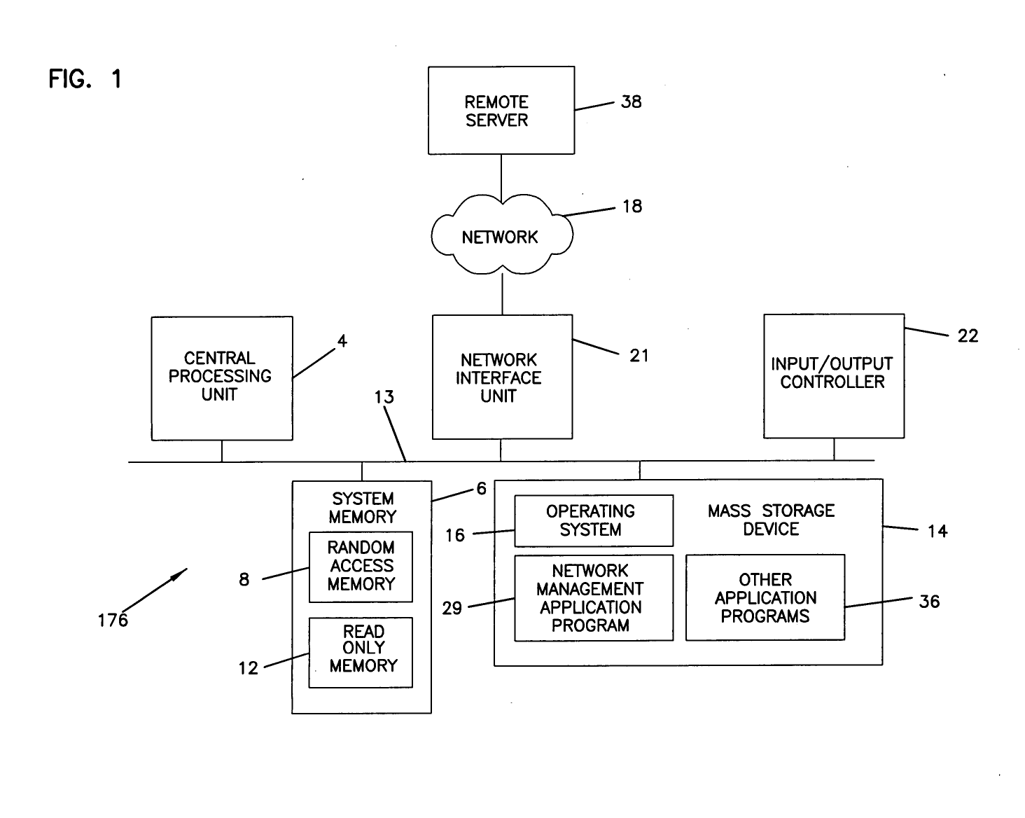

Referring now to FIG. 1, a device for supplying an array data processing input in one embodiment comprises a computer 176, which is connected to a network server 38 via a network connection 18. Versions of data processing inputs can be stored on the network server 38 for download. The input may be stored in one or more databases on the network server 38, which may execute software, which upon requests from a client computer, can search the database to retrieve the data processing inputs that a user at the client computer is interested in. A wide variety of computers can be programmed to carry out the method described below. In particular, a general-purpose computer may be used. A general-purpose computer 176 typically has a central processing unit (CPU) 4, system memory 6, a mass storage device 14, a network interface unit 21 and an input/output controller 22, all interconnected by a data bus 13. The system memory 6 includes random-access memory and read-only memory for storing the program being executed by the CPU 4. The mass storage device 14, such as a magnetic hard drive or optical disc drive, stores the operating system 16, network management application program 29 and other application programs 36 for loading into the system memory 6 for execution by the CPU 4. The input/output controller 22 manages input devices such as keyboard and mouse and output devices such as display monitor and sound systems. Finally, the network interface unit 21 manages the communication between the computer 176 and the network 18.

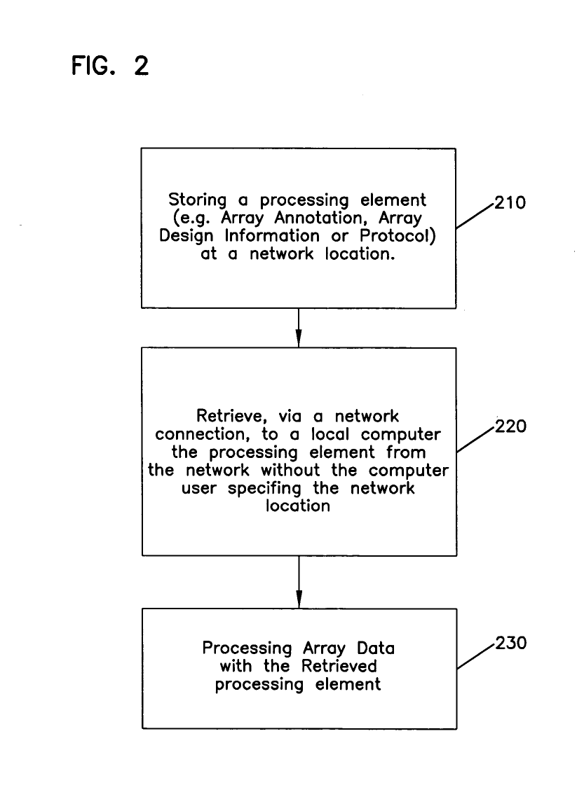

Referring to FIG. 2, in one illustrative embodiment, a method 200 of supplying an array data processing input for analyzing a microarray includes accessing 210, from a computer, a storage unit via a predetermined network connection without a user of the computer specifying the network location; and receiving 220 into the computer from the storage unit through the network connection the array data processing inputs. The method 200 in this illustrative embodiment also includes processing 230 data from the microarray using the retrieved array data processing input.

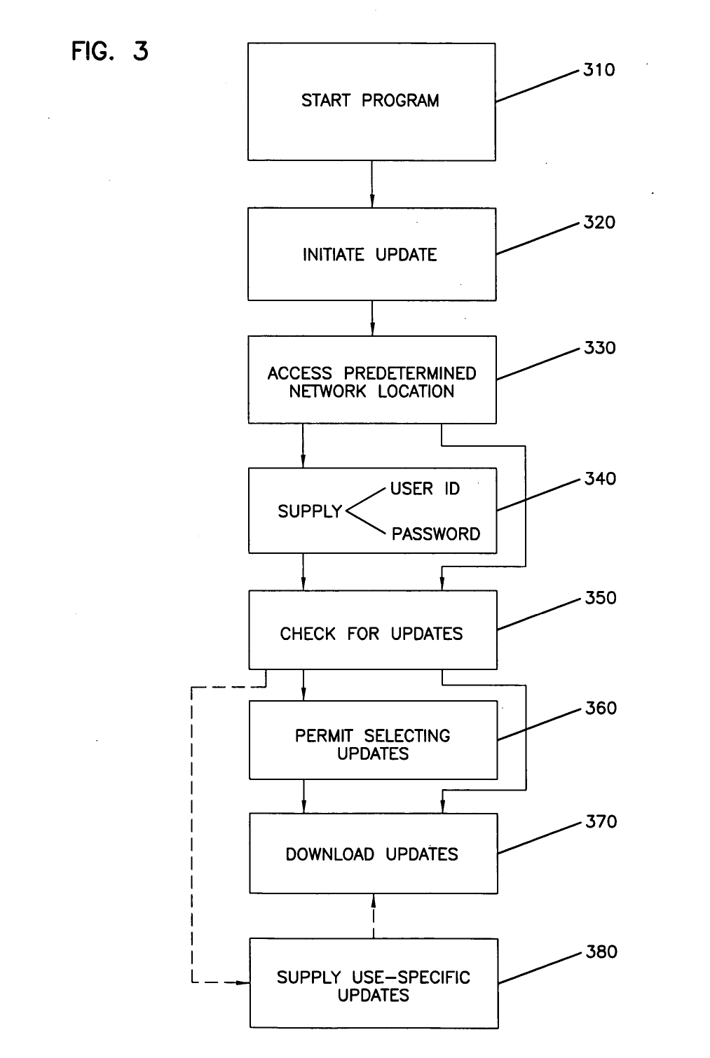

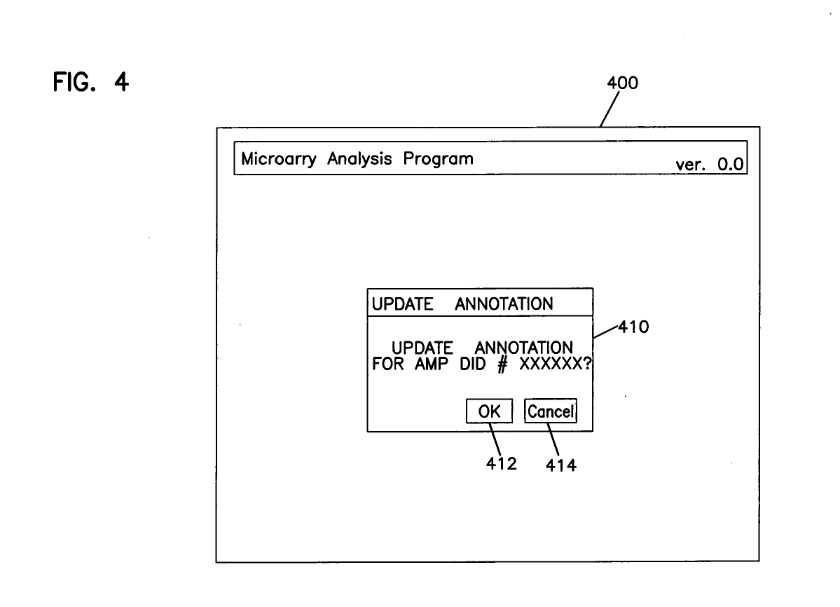

More specifically, as outlined in FIG. 3, in an illustrative embodiment, a user starts 310 the array data processing program in a local, or client, computer to analyze a set of microarray data, which can be an image file (e.g., in TIFF format) representing spots of varying sizes and intensity distributions. The program initiates 320 an update function in the form, for example, of a dialog box 410, as shown in FIG. 4, with user input buttons (“OK” (412) to confirm, and “Cancel” (412) to stop). Upon the user confirming the updating function by issuing an access command (clicking on the “OK” button) but without the user specifying a network address, the program accesses (330) a predetermined website or other network location. In this illustrative embodiment, the network address (such as the Universal Resource Locator (“URL”) of a website) through which the updated array data processing inputs are available is preloaded in the processing software in a database. In practice, the network address may or may not be the address where the inputs are physically located. In the case where they are not, as in the case where the network server has been changed to a different address, the access command can be redirected or mapped (for example, by the gateway at the address) to the location where the inputs are physically located. In an alternative embodiment, the program provides a user interface for the user to type in the network address. The program can further store the user-typed network address in a database so that a user does not need to specify the network address again in the subsequent uses of the program. In another illustrative embodiment, the program can access a predetermined website or other network location without prompting the user.

Upon prompting by the website or network location, the user supplies (340) a set of user preconfigured access credentials, such as user login name and password. Once the access to the content of the website or network location is authorized, the program checks (350) for updates to data processing inputs (such as protocols, array annotations and/or array design information).

The data processing inputs being checked for update may already have been loaded in the local computer, e.g., preloaded in the software or absent from the local computer. Data processing inputs include analysis protocols, which specify how to extract chemical information such as DNA information from the microarray data, or design files, which contain microarray design parameters such as array size, number of columns, number of rows and chemical composition at each spot. Each data processing input can have different versions. For example, even for the same microarray, more properties useful for analysis may be discovered over time. Thus, updated versions of design files may be added to the network server for downloading by client computers. Analysis protocol may also change as more advantageous protocols are developed. Each version of a set of data analysis inputs may be uniquely identified by a set of attributes, such as an identification code, a version number, and a release date.

In the illustrative embodiment, the version of the data processing input on the local computer is compared with a version of the data processing input at the website of network location. For example, the release date of a protocol on the client computer is compared to the release date of a protocol with the same protocol identification code on the network server. More specifically, in this embodiment, the protocol itself and its version information are stored in a file, either on the client computer or on the network server. When the user issues a command for update of a particular protocol, the network server searches for, and retrieves the version information of, the most current version of the protocol. The version information of the protocol on both the client computer and the network server can be displayed on the monitor of the client computer. The version at the website or network location can be downloaded if it is the more updated version (e.g., with a later release date) of the two.

Alternatively, if the local computer does not already have any version of the data processing input loaded, the user can download the most current version of the data processing input by specifying an appropriate identifier, such as an Agilent Microarray Design Identification (AMADID) number for design files. Certain such identifiers can be embedded in the microarray data and can be readily supplied to the network server, in certain cases even without user manually typing in the identifier. For example, AMADIDs are typically affixed on microarrays as barcodes and are scanned into the image file by the data acquisition equipment and software. The data processing program can retrieve the AMADID from the image file and supply the AMADID to the network server in requesting appropriate design file and/or protocol.

The program optionally lists the available updates and permits (360) the user to select among the available updates for those that are desired. The program then downloads (370) the approved updated array data processing input(s) and installs the information into the program so that subsequent processing and analysis can use the updated information.

In some cases, such as custom microarray designs, certain updates may be provided to specific customer(s), sometimes on a confidential basis. In these cases, the user can by required to supply (380) access credentials, such as an under ID and password, to access the updates.

The devices and methods in the illustrative embodiments thus provide an automated and streamlined process for a user of microarrays to process the data from the microarray using the most updated, or user selected, array data processing inputs.

Kits for use in connection with the subject invention may also be provided. Such kits preferably include at least a computer readable medium including programming as discussed above and instructions. The instructions may include installation or setup directions. The instructions may include directions for use of the invention with options or combinations of options as described above. In certain embodiments, the instructions include both types of information.

Providing the software and instructions as a kit may serve a number of purposes. The combination may be packaged and purchased as a means of upgrading an existing scanner, computer, or other device for accessing genomic information and presenting the user interface described herein. Alternately, the combination may be provided in connection with a new scanner in which the software is preloaded on the same. In which case, the instructions will serve as a reference manual (or a part thereof and the computer readable medium as a backup copy to the preloaded utility.

The instructions are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging), etc. In other embodiments, the instructions are present as an electronic storage data file present on a suitable computer readable storage medium, e.g., CD-ROM, diskette, etc, including the same medium on which the program is presented.

In yet other embodiments, the instructions are not themselves present in the kit, but means for obtaining the instructions from a remote source, e.g. via the Internet, are provided. An example of this embodiment is a kit that includes a web address where the instructions can be viewed and/or from which the instructions can be downloaded. Conversely, means may be provided for obtaining the subject programming from a remote source, such as by providing a web address. Still further, the kit may be one in which both the instructions and software are obtained or downloaded from a remote source, as in the Internet or worldwide web. Some form of access security or identification protocol may be used to limit access to those entitled to use the subject invention. As with the instructions, the means for obtaining the instructions and/or programming is generally recorded on a suitable recording medium.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method of supplying an array data processing input for analyzing a microarray, the method comprising:
from a computer, accessing a storage unit at a predetermined network location via a network connection without a user of the computer specifying the network location; and
receiving into the computer from the storage unit through the network connection the array data processing input.

2. The method of claim 1, wherein retrieving the array data processing input comprises retrieving array design information, array annotation or a processing protocol for the microarray.

3. The method of claim 1, further comprising comparing an update status indicator of the array data processing input at the network location with an update status indicator of array data processing input at the computer, and retrieving the array data processing input at the network location only when the result of the comparison meets a predetermined condition.

4. The method of claim 3, wherein each update status indicators comprises a version number or an array data processing input release date.

5. The method of claim 1, further comprising authenticating the user for the network location before permitting the retrieval of the array data processing input from the network location.

6. The method of claim 1, further comprising authenticating the user for the array data processing input at the network location before permitting the retrieval of the array data processing input from the network location.

7. The method of claim 1, further comprising providing at the network location a plurality of array data processing inputs, each having associated with it a respective update status indicator, and permitting the user to selectively retrieve at least one of the plurality of array data processing inputs.

8. A computer-readable medium having stored thereon computer-readable codes that, when executed by a computer, causes the computer to access a storage unit at a predetermined network location via a network connection without a user of the computer specifying the network location; and receive into the computer from the storage unit through the network connection the array data processing input.

9. The computer-readable medium of claim 8, wherein when executed by the computer, the computer-readable codes further causes the computer to process data of the microarray using the retrieved array data processing inputs.

10. The computer-readable medium of claim 8, wherein the array data processing input comprises retrieving array design information, array annotation or processing protocol for the microarray.

11. The computer-readable medium of claim 9, wherein when executed by the computer, the codes further cause the computer to compare an update status indicator of the array data processing input at the network location with an update status indicator of array data processing input at the computer, and retrieve the array data processing input at the network location only when the result of the comparison meets a predetermined condition.

12. The computer-readable medium of claim 8, wherein when executed by the computer, the codes further cause the computer to authenticate the user for the network location before permitting the retrieval of the array data processing input from the network location.

13. The computer-readable medium of claim 8, wherein when executed by the computer, the codes further cause the computer to authenticate the user for the array data processing input at the network location before permitting the retrieval of the array data processing input from the network location.

14. The computer-readable medium of claim 8, wherein when executed by the computer, the codes further cause the computer to access a plurality of array data processing inputs at the network location, each having associated with it a respective update status indicator, and selectively retrieve at least one of the plurality of array data processing inputs.

15. A device for analyzing a microarray, the device comprising
a computer having a network interface adapted to enable the computer to access a storage unit via a network connection; and
a computer-readable medium in data communication with the computer, the medium having stored thereon codes that, when executed by the computer, causes the computer to retrieve to the computer, through the network connection, the array data processing input from the network location without a user of the computer specifying the network location.

16. The device of claim 15, wherein the array data processing input comprises retrieving array design information, array annotation or processing protocol for the microarray.

17. The method of claim 15, wherein the codes, when executed by the computer, further cases the computer to compare an update status indicator of the array data processing input at the network location with an update status indicator of array data processing input at the computer, and retrieve the array data processing input at the network location only when the result of the comparison meets a predetermined condition.

18. The method of claim 17, wherein the method further comprising authenticating the user for the array data processing input at the network location before permitting the retrieval of the array data processing input from the network location.
